(19) United States
(12) Patent Application Publication
(10) Pub. No.: US 2021/0305579 A1
(43) Pub. Date: Sep. 30, 2021

(54) BATTERY

(71) Applicant: Panasonic Intellectual Property Management Co., Ltd., Osaka (JP)

(72) Inventor: EIICHI KOGA, Osaka (JP)

(21) Appl. No.: 17/343,631

(22) Filed: Jun. 9, 2021

Related U.S. Application Data
(63) Continuation of application No. PCT/JP2019/045138, filed on Nov. 18, 2019.

(30) Foreign Application Priority Data
Dec. 28, 2018 (JP) 2018-248601

(51) Int. Cl. H01M 4/64; H01M 50/531; H01M 10/0562; H01M 10/0585; H01M 50/543

(52) U.S. Cl. CPC H01M 4/64; H01M 50/531; H01M 50/543; H01M 10/0585; H01M 10/0562

(57) ABSTRACT

A battery according to the present disclosure includes a plurality of cells that are electrically connected in parallel. Each of the plurality of cells includes a positive electrode layer, a negative electrode layer, a current collector that is in contact with the positive electrode layer or the negative electrode layer, and an electrolyte layer disposed between the positive electrode layer and the negative electrode layer. A side surface of the current collector includes an exposed portion exposed from the electrolyte layer and a shielded portion shielded by the electrolyte layer, and an area of the shielded portion is larger than an area of the exposed portion.

### BACKGROUND

### 1. Technical Field

The present disclosure relates to a battery.

### 2. Description of the Related Art

A capacity can be increased by electrically connecting batteries in parallel. As a technique related to such parallel connection, for example, Japanese Unexamined Patent Application Publication No. 2007-103129 (hereinafter referred to as Patent Literature 1) discloses a thin-film solid-state secondary battery having an electrode extraction part at an end of a current collector body. Japanese Unexamined Patent Application Publication No. 2013-120717 (hereinafter referred to as Patent Literature 2) discloses an all-solid-state battery in which a current collector for a terminal is attached to an end surface of a multilayer body.

### SUMMARY

In the conventional arts, there are demands for a battery having high reliability.

In one general aspect, the techniques disclosed here feature a battery including a plurality of cells that are electrically connected in parallel. Each of the plurality of cells includes a positive electrode layer, a negative electrode layer, a current collector that is in contact with the positive electrode layer or the negative electrode layer, and an electrolyte layer disposed between the positive electrode layer and the negative electrode layer. A side surface of the current collector includes an exposed portion exposed from the electrolyte layer and a shielded portion shielded by the electrolyte layer, and an area of the shielded portion is larger than an area of the exposed portion.

According to the present disclosure, a battery having high reliability can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view and a top view schematically illustrating a configuration of a battery according to the first embodiment;

FIG. 2 is a top view of a negative electrode current collector;

FIG. 3 is a cross-sectional view and a top view schematically illustrating a configuration of a battery according to the second embodiment;

FIG. 4 is a cross-sectional view and a top view schematically illustrating a configuration of a battery according to the third embodiment;

FIG. 5 is a cross-sectional view and a top view schematically illustrating a configuration of a battery according to the fourth embodiment; and

FIG. 6 is a cross-sectional view and a top view schematically illustrating a configuration of a battery according to the fifth embodiment.

### DETAILED DESCRIPTION

### Outline of Aspect of Present Disclosure

A battery according to a first aspect of the present disclosure includes a plurality of cells that are electrically connected in parallel, each of the plurality of cells including a positive electrode layer, a negative electrode layer, a current collector that is in contact with the positive electrode layer or the negative electrode layer, and an electrolyte layer disposed between the positive electrode layer and the negative electrode layer,

wherein a side surface of the current collector includes an exposed portion exposed from the electrolyte layer and a shielded portion shielded by the electrolyte layer, and

an area of the shielded portion is larger than an area of the exposed portion.

According to the first aspect, a battery having high reliability can be provided.

In a second aspect of the present disclosure, for example, the battery according to the first aspect may further include a terminal electrically connected to the current collector, wherein the exposed portion is in contact with the terminal. According to such a structure, a joining strength between the current collector and the electrolyte layer can be improved.

In a third aspect of the present disclosure, for example, the battery according to the first or second aspect may be configured such that the electrolyte layer is a solid electrolyte layer containing a solid electrolyte. According to such a structure, a battery having high reliability can be provided.

In a fourth aspect of the present disclosure, for example, the battery according to any one of the first through third aspects may be configured such that the electrolyte layers of adjacent ones of the plurality of cells are joined to each other around the shielded portion. According to such a structure, the battery can be increased in capacity.

In a fifth aspect of the present disclosure, for example, the battery according to any one of the first through fourth aspects may be configured such that the current collector has a protruding portion; and the exposed portion is included in the protruding portion. According to such a structure, the current collector can be efficiently connected to an electrode terminal.

In a sixth aspect of the present disclosure, for example, the battery according to the fifth aspect may be configured such that the current collector has a remaining portion other than the protruding portion; and a width of the protruding portion is smaller than a width of the remaining portion. According to such a structure, a portion where peeling is easy to occur between the current collector and the electrolyte layer can be reduced.

In a seventh aspect of the present disclosure, for example, the battery according to the fifth or sixth aspect may be configured such that the current collector has a remaining portion other than the protruding portion; and a thickness of the protruding portion is smaller than a thickness of the remaining portion. According to such a structure, a portion where peeling is easy to occur between the current collector and the electrolyte layer can be reduced.

In an eighth aspect of the present disclosure, for example, the battery according to any one of the first through seventh aspects may be configured such that the current collector has a through hole. According to such a structure, a joining strength between the current collector and the electrolyte layer can be improved.

In a ninth aspect of the present disclosure, for example, the battery according to the eighth aspect may be configured such that the electrolyte layer is present in the through hole. According to such a structure, a joining strength between the current collector and the electrolyte layer can be improved.

In a tenth aspect of the present disclosure, for example, the battery according to any one of the first through ninth aspects may further include a joining layer, wherein the joining layer is located on an interface between the current collector and the electrolyte layer and contains at least one kind of element among elements contained in the current collector and at least one kind of element among elements contained in the electrolyte layer. According to such a structure, a joining strength between the current collector and the electrolyte layer can be improved.

In an eleventh aspect of the present disclosure, for example, the battery according to the tenth aspect may be configured such that the joining layer is present on an interface between the shielded portion and the electrolyte layer. According to such a structure, a joining strength between the current collector and the electrolyte layer can be improved.

In a twelfth aspect of the present disclosure, for example, the battery according to any one of the first through eleventh aspects may further include a dummy current collector around the shielded portion of the current collector. According to such a structure, variations in pressure can be further reduced during pressure bonding.

In a thirteenth aspect of the present disclosure, for example, the battery according to the twelfth aspect may be configured such that the dummy current collector contains the same material as the current collector. According to such a structure, variations in pressure can be further reduced during pressure bonding.

In a fourteenth aspect of the present disclosure, for example, the battery according to the twelfth aspect may be configured such that the dummy current collector contains an insulating material. According to such a structure, variations in pressure can be further reduced.

In a fifteenth aspect of the present disclosure, for example, the battery according to any one of the twelfth through fourteenth aspects may be configured such that the dummy current collector is electrically separate from the current collector. According to such a structure, a battery having high reliability can be provided.

In a sixteenth aspect of the present disclosure, for example, the battery according to the fifteenth aspect may be configured such that the dummy current collector is separate from the current collector. According to such a structure, a battery having high reliability can be provided.

In a seventeenth aspect of the present disclosure, for example, the battery according to any one of the twelfth through sixteenth aspects may be configured such that the dummy current collector is exposed from the electrolyte layer. According to such a structure, variations in pressure can be further reduced during pressure bonding.

In an eighteenth aspect of the present disclosure, for example, the battery according to any one of the twelfth through seventeenth aspects may be configured such that each of the plurality of cells has a flat plate shape; the plurality of cells are laminated on one another to constitute the battery; and the dummy current collector is located at the same height as the current collector in a direction in which the plurality of cells are laminated. According to such a structure, a portion where peeling is easy to occur between the current collector and the electrolyte layer can be reduced.

In a nineteenth aspect of the present disclosure, for example, the battery according to any one of the twelfth through seventeenth aspects may be configured such that each of the plurality of cells has a flat plate shape; the plurality of cells are laminated on one another to constitute the battery; and the dummy current collector is located at a height different from the current collector in a direction in which the plurality of cells are laminated. According to such a structure, a portion where peeling is easy to occur between the current collector and the electrolyte layer can be reduced.

Embodiments are described in detail below with reference to the drawings.

Each of the embodiments below illustrates a general or specific example. Numerical values, shapes, materials, constituent elements, a way in which the constituent elements are disposed and connected, and the like in the embodiments below are merely examples and do not limit the present disclosure. Among constituent elements in the embodiments below, constituent elements that are not recited in independent claims indicative of highest concepts are described as optional elements.

Illustration in each drawing is not necessarily strict. In the drawings, substantially identical constituent elements are given identical reference signs, and repeated description thereof is omitted or simplified.

### First Embodiment

### Outline of Laminated Battery

First, a battery according to the present embodiment is described.

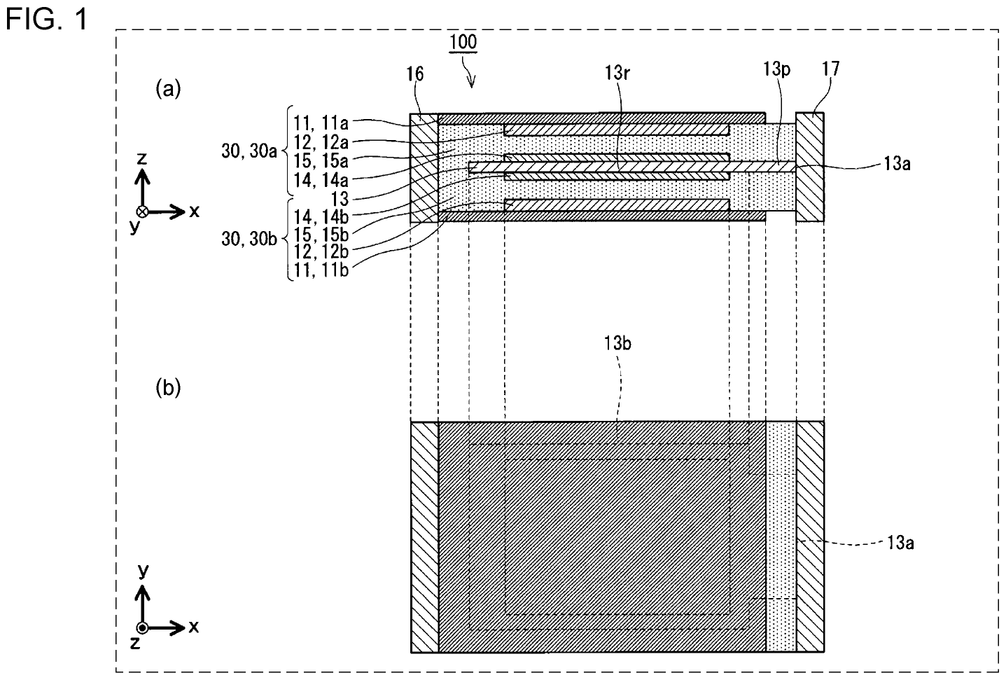

FIG. 1 is a schematic view for explaining a configuration of a laminated battery 100 according to the first embodiment. In the present embodiment, the battery 100 is a laminated battery. Therefore, the “battery 100” is hereinafter sometimes referred to as a “laminated battery 100”. FIG. 1(a) is a cross-sectional view of the battery 100 according to the present embodiment. FIG. 1(b) is a top view of the battery 100.

As illustrated in FIG. 1(a), the battery 100 includes a plurality of cells 30, a positive electrode terminal 16, and a negative electrode terminal 17. Hereinafter, a “cell” is sometimes referred to as a “solid-state battery cell”. The plurality of cells 30 are electrically connected in parallel. As illustrated in FIG. 1(b), each of the plurality of cells 30 has, for example, a rectangular shape in plan view. Each of the plurality of cells 30 has two pairs of end surfaces that face each other. Each of the plurality of cells 30 has, for example, a flat-plate shape. The battery 100 is constituted by the plurality of cells 30 laminated on one another. In the present embodiment, a first direction x is a direction from one of a pair of end surfaces of a specific cell 30 toward the other one of the pair of end surfaces. A second direction y is a direction from one of the other pair of end surfaces of the specific cell 30 toward the other one of the other pair of end surfaces and is orthogonal to the first direction x. A third direction z is a direction in which the plurality of cells 30 are laminated and is orthogonal to the first direction x and the second direction y.

The number of cells 30 is not limited in particular and may be equal to or greater than 20 and equal to or less than 100, may be equal to or greater than 2 and equal to or less than 100, or may be equal to or greater than 2 and equal to or less than 10. In the present embodiment, the battery 100 includes a plurality of cells 30a and 30b. The plurality of cells 30a and 30b are laminated in this order.

The positive electrode terminal 16 and the negative electrode terminal 17 are electrically connected to the plurality of cells 30. The positive electrode terminal 16 and the negative electrode terminal 17 each have, for example, a plate shape. The positive electrode terminal 16 and the negative electrode terminal 17 face each other. The positive electrode terminal 16 and the negative electrode terminal 17 are aligned in the first direction x. The plurality of cells 30 are located between the positive electrode terminal 16 and the negative electrode terminal 17. Hereinafter, the positive electrode terminal 16 and the negative electrode terminal 17 are sometimes simply referred to as “terminals”.

Each of the plurality of cells 30 has a positive electrode current collector 11, a positive electrode layer 12, a negative electrode current collector 13, a negative electrode layer 14, and an electrolyte layer 15. The positive electrode current collector 11, the positive electrode layer 12, the electrolyte layer 15, the negative electrode layer 14, and the negative electrode current collector 13 are aligned in this order in the third direction z or a direction opposite to the third direction z. Hereinafter, the positive electrode current collector 11 and the negative electrode current collector 13 are sometimes simply referred to as “current collectors”.

The positive electrode current collector 11 has, for example, a plate shape. The positive electrode current collector 11 is electrically connected to the positive electrode layer 12 and the positive electrode terminal 16. The positive electrode current collector 11 may be directly connected to the positive electrode layer 12 and the positive electrode terminal 16. For example, a main surface of the positive electrode current collector 11 may be directly connected to the positive electrode layer 12. The “main surface” is a surface of the positive electrode current collector 11 that has a largest area. An end (end surface) of the positive electrode current collector 11 may be in direct contact with the positive electrode terminal 16. The positive electrode current collector 11 and the negative electrode terminal 17 are electrically separate from each other with a gap interposed therebetween. A shortest distance between the positive electrode current collector 11 and the negative electrode terminal 17 is not limited in particular and may be equal to or greater than 20 μm and equal to or less than 100 μm, may be equal to or greater than 1 μm and equal to or less than 100 μm, or may be equal to or greater than 1 μm and equal to or less than 10 μm. Hereinafter, a vicinity of an end surface of each cell 30 is sometimes referred to as an “end region”. The positive electrode current collector 11 and the negative electrode terminal 17 are, for example, electrically separate from each other with a gap interposed therebetween in the end region of the cell 30.

The positive electrode layer 12 has, for example, a rectangular shape in plan view. The positive electrode layer 12 is disposed on the positive electrode current collector 11. The positive electrode layer 12, for example, partially covers the main surface of the positive electrode current collector 11. The positive electrode layer 12 may cover a region including a center of gravity of the main surface of the positive electrode current collector 11. The positive electrode layer 12 is, for example, not provided in the end region of the cell 30.

The negative electrode current collector 13 has, for example, a plate shape. The negative electrode current collector 13 is electrically connected to the negative electrode layer 14 and the negative electrode terminal 17. The negative electrode current collector 13 may be in direct contact with the negative electrode layer 14 and the negative electrode terminal 17. For example, a main surface of the negative electrode current collector 13 may be in direct contact with the negative electrode layer 14. An end (end surface) of the negative electrode current collector 13 may be in direct contact with the negative electrode terminal 17. The negative electrode current collector 13 and the positive electrode terminal 16 are electrically separate from each other with a gap interposed therebetween. A shortest distance between the negative electrode current collector 13 and the positive electrode terminal 16 is not limited in particular and may be equal to or greater than 20 μm and equal to or less than 100 μm, may be equal to or greater than 1 μm and equal to or less than 100 μm, or may be equal to or greater than 1 μm and equal to or less than 10 μm. The negative electrode current collector 13 and the positive electrode terminal 16 are electrically separate from each other with a gap interposed therebetween, for example, in the end region of the cell 30. In the present embodiment, an exposed portion 13a of the negative electrode current collector 13 is in contact with the negative electrode terminal 17. In other words, the negative electrode current collector 13 has the exposed portion 13a as a contact surface with the negative electrode terminal 17. Side surfaces of the negative electrode current collector 13 are made up of the exposed portion 13a and a shielded portion 13b. The “side surfaces” mean surfaces other than the main surface of the negative electrode current collector 13. The “main surface” means a surface of the negative electrode current collector 13 that has a largest area. The negative electrode current collector 13 is not exposed to an outside except for the exposed portion 13a.

A position of the negative electrode current collector 13 is, for example, deviated from a position of the positive electrode current collector 11 in the first direction x. In plan view, the gap between the negative electrode current collector 13 and the positive electrode terminal 16 does not overlap, for example, the gap between the positive electrode current collector 11 and the negative electrode terminal 17.

The negative electrode layer 14 has, for example, a rectangular shape in plan view. The negative electrode layer 14 is disposed on the negative electrode current collector 13. The negative electrode layer 14, for example, partially covers the main surface of the negative electrode current collector 13. The negative electrode layer 14 may cover a region including a center of gravity of the main surface of the negative electrode current collector 13. The negative electrode layer 14 is, for example, not provided in the end region of the cell 30.

The electrolyte layer 15 is located between the positive electrode current collector 11 and the negative electrode current collector 13. In other words, the electrolyte layer 15 is located between the positive electrode layer 12 and the negative electrode layer 14. The electrolyte layer 15 is in contact with the positive electrode terminal 16 and the negative electrode terminal 17. The electrolyte layer 15 may be in contact with the positive electrode layer 12 and the negative electrode layer 14.

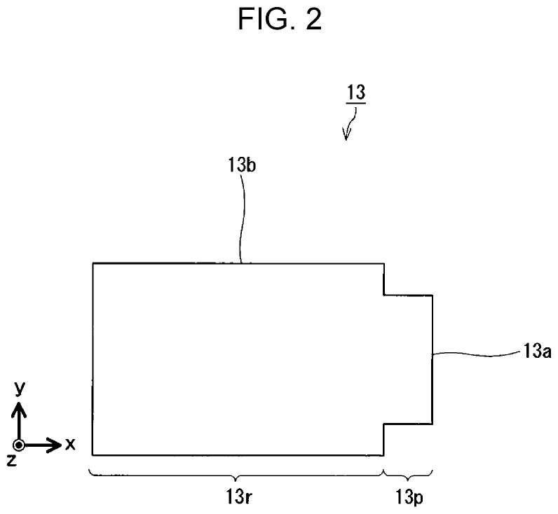

FIG. 2 is a top view of the negative electrode current collector 13.

As illustrated in FIGS. 1 and 2, the side surfaces of the negative electrode current collector 13 have the exposed portion 13a and the shielded portion 13b. The exposed portion 13a is a portion exposed from the electrolyte layer 15. The shielded portion 13b is a portion shielded from an outside by the electrolyte layer 15. In other words, the shielded portion 13b is a non-exposed portion that is not exposed from the electrolyte layer 15. In the present embodiment, an area of the shielded portion 13b is larger than an area of the exposed portion 13a. According to such a configuration, the large-capacity laminated battery 100 having features such as a small size, good shock resistance, a high energy density, and high reliability can be provided.

A ratio (S2/S1) of the area S2 of the shielded portion 13b to the area S1 of the exposed portion 13a is decided appropriately depending on a size, a material, and the like of the battery 100 and therefore is not limited in particular. The ratio (S2/S1) is, for example, within a range of equal to or greater than 2 and equal to or less than 50.

In the present embodiment, the negative electrode current collector 13 has a protruding portion 13p and a remaining portion 13r. The protruding portion 13p is a tab-shaped portion. The remaining portion 13r is a portion other than the protruding portion 13p. An area (area in plan view) of the protruding portion 13p is smaller than an area (area in plan view) of the remaining portion 13r. In the present embodiment, the protruding portion 13p and the remaining portion 13r each has a rectangular shape. However, the shapes of the protruding portion 13p and the remaining portion 13r are not limited in particular. The exposed portion 13a is located on a side surface of the protruding portion 13p. The exposed portion 13a is not in contact with the electrolyte layer 15. The exposed portion 13a is electrically connected to the negative electrode terminal 17. In the present embodiment, the whole exposed portion 13a is included in the protruding portion 13p. However, only part of the exposed portion 13a may be included in the protruding portion 13p. The shielded portion 13b is located on side surfaces of the remaining portion 13r and side surfaces of the protruding portion 13p. However, the shielded portion 13b does not include the exposed portion 13a among the side surfaces of the protruding portion 13p. The shielded portion 13b is in contact with the electrolyte layer 15. A main surface of the remaining portion 13r may be in direct contact with the negative electrode layer 14 and the electrolyte layer 15. A main surface of the protruding portion 13p may be in direct contact with the electrolyte layer 15. According to such a configuration, a large portion of the negative electrode current collector 13 can be embedded in the electrolyte layer 15. This makes it possible to connect the negative electrode current collector 13 to the negative electrode terminal 17 while reducing an area of a portion from which interlayer peeling can occur.

In the negative electrode current collector 13, the protruding portion 13p is a portion that extends from the remaining portion 13r in the first direction x. A length of the protruding portion 13p of the negative electrode current collector 13 in the second direction y is shorter than a length of the remaining portion 13r in the second direction y. That is, a width of the protruding portion 13p is smaller than a width of the remaining portion 13r. According to such a configuration, an area of the exposed portion 13a can be reduced. Furthermore, an interface between the exposed portion 13a and the electrolyte layer 15 is reduced. As a result, a portion where peeling is easy to occur between the negative electrode current collector 13 and the electrolyte layer 15 can be reduced, and therefore the battery 100 having high reliability can be provided.

In the present embodiment, a width direction of the battery 100 is a direction parallel with the second direction y and orthogonal to the first direction x and the third direction z. A direction in which the plurality of cells 30 are laminated is parallel with the third direction z. The width of the protruding portion 13p and the width of the remaining portion 13r are dimensions of the respective portions in the width direction when the battery 100 is viewed in plan view.

The shielded portion 13b of the negative electrode current collector 13 is firmly held by the electrolyte layer 15 having a high adhesion strength. Around the shielded portion 13b, the electrolyte layers 15 of adjacent cells 30 are joined to each other. In the present embodiment, the negative electrode current collector 13 and the electrolyte layer 15 can be firmly joined to each other by connecting the plurality of cells 30 in parallel while sharing the negative electrode current collector 13. This can reduce a portion where peeling is easy to occur between the negative electrode current collector 13 and the electrolyte layer 15. According to such a configuration, the large-capacity laminated battery 100 having features such as a small size, good shock resistance, a high energy density, and high reliability can be provided.

As described above, the battery 100 includes the plurality of cells 30a and 30b. The cell 30a has a positive electrode current collector 11a, a positive electrode layer 12a, the negative electrode current collector 13, a negative electrode layer 14a, and an electrolyte layer 15a. The cell 30b has a positive electrode current collector 11b, a positive electrode layer 12b, the negative electrode current collector 13, a negative electrode layer 14b, and an electrolyte layer 15b. The negative electrode current collector 13 is shared by the cells 30a and 30b. The plurality of positive electrode current collectors 11a and 11b and the negative electrode current collector 13 are alternately arranged in the third direction z. In the gap between the negative electrode current collector 13 and the positive electrode terminal 16, the electrolyte layer 15a may be in contact with the electrolyte layer 15b.

### Configuration of Laminated Battery

The constituent elements of the battery 100 are described in more detail below.

First, the constituent elements of the battery 100 according to the embodiment of the present disclosure are described.

The positive electrode layer 12 functions as a positive electrode active material layer containing a positive electrode active material. The positive electrode layer 12 may contain a positive electrode active material as a main component. The main component refers to a component that is contained most in the positive electrode layer 12 by weight. The positive electrode active material refers to a material in which metal ions such as lithium (Li) ions or magnesium (Mg) ions are inserted or removed in a crystal structure thereof at a potential higher than a negative electrode and oxidation or reduction is performed accordingly. An appropriate kind of positive electrode active material can be selected depending on the kind of battery, and a known positive electrode active material can be used. The positive electrode active material is, for example, a compound containing lithium and a transition metal element. Examples of the compound include an oxide containing lithium and a transition metal element and a phosphate compound containing lithium and a transition metal element. Examples of the oxide containing lithium and a transition metal element include a lithium-nickel composite oxide such as LiNiₓM₁₋ₓO₂ (M is at least one element selected from the group consisting of Co, Al, Mn, V, Cr, Mg, Ca, Ti, Zr, Nb, Mo, and W, and x is greater than 0 and equal to or less than 1), a layered oxide such as a lithium cobalt oxide (LiCoO₂), a lithium nickel oxide (LiNiO₂), or a lithium manganese oxide (LiMn₂O₄), and a lithium manganese oxide (LiMn₂O₄, Li₂MnO₃, LiMO₂) having a spinel structure. As the phosphate compound containing lithium and a transition metal element, lithium iron phosphate (LiFePO₄) having an olivine structure is, for example, used. The positive electrode active material may be a sulfide such as sulfur (S) or lithium sulfide (Li₂S). The positive electrode active material may be particles containing a sulfide coated or doped with lithium niobate (LiNbO₃). The positive electrode active materials may be used alone or may be used in combination of two or more kinds.

As described above, the positive electrode layer 12 is not limited in particular as long as the positive electrode layer 12 contains a positive electrode active material. The positive electrode layer 12 may be a mixture layer made of a mixture of a positive electrode active material and an additive. The additive can be, for example, a solid electrolyte such as an inorganic solid electrolyte, a conductive additive such as acetylene black, or a binder such as polyethylene oxide or polyvinylidene fluoride. By mixing a positive electrode active material and an additive at a predetermined ratio in the positive electrode layer 12, not only lithium ion conductivity but also electron conductivity in the positive electrode layer 12 can be improved.

A thickness of the positive electrode layer 12 is, for example, equal to or greater than 5 μm and equal to or less than 300 μm.

The negative electrode layer 14 functions as a negative electrode active material layer containing a negative electrode material such as a negative electrode active material. The negative electrode layer 14 may contain a negative electrode material as a main component. The negative electrode active material refers to a material in which metal ions such as lithium (Li) ions or magnesium (Mg) ions are inserted or removed in a crystal structure thereof at a potential lower than a positive electrode and oxidation or reduction is performed accordingly. An appropriate kind of negative electrode active material can be selected depending on a kind of battery, and a known negative electrode active material can be used. Examples of the negative electrode active material include carbon materials such as natural graphite, artificial graphite, graphite carbon fibers, and resin heat-treat carbon and alloy materials to be mixed with a solid electrolyte. Examples of the alloy materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element such as lithium titanate (Li₄Ti₅O₁₂), and metal oxides such as zinc oxide (ZnO) and silicon oxide (SiOₓ). The negative electrode active materials may be used alone or may be used in combination of two or more kinds.

As described above, the negative electrode layer 14 is not limited in particular as long as the negative electrode layer 14 contains a negative electrode active material. The negative electrode layer 14 may be a mixture layer made of a mixture of a negative electrode active material and an additive. The additive can be, for example, a solid electrolyte such as an inorganic solid electrolyte, a conductive additive such as acetylene black, or a binder such as polyethylene oxide or polyvinylidene fluoride. By mixing a negative electrode active material and an additive at a predetermined ratio in the negative electrode layer 14, not only lithium ion conductivity but also electron conductivity in the negative electrode layer 14 can be improved.

A thickness of the negative electrode layer 14 is, for example, equal to or greater than 5 μm and equal to or less than 300 μm.

The electrolyte layer 15 may be a solid electrolyte layer containing a solid electrolyte. The solid electrolyte is not limited in particular as long as the solid electrolyte has ion conductivity, and a known electrolyte for a battery can be used. The solid electrolyte can be, for example, an electrolyte that conducts metal ions such as Li ions or Mg ions. An appropriate kind of solid electrolyte can be selected depending on a kind of conducted ions. The solid electrolyte can be, for example, an inorganic solid electrolyte such as a sulfide solid electrolyte or an oxide solid electrolyte. The sulfide solid electrolyte can be, for example, a lithium-containing sulfide such as Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, or Li₂SGeS₂—ZnS. The oxide solid electrolyte can be, for example, a lithium-containing metal oxide such as Li₂O—SiO₂ or Li₂O—SiO₂—P₂O₅, a lithium-containing metal nitride such as LiₓP_{y}O_{1-z}N_{z}, or a lithium-containing transition metal oxide such as lithium phosphate (Li₃PO₄) or lithium titanium oxide. As the solid electrolyte, only one kind selected from these materials may be used or two or more kinds selected from these materials may be used in combination.

The electrolyte layer 15 may contain a binder such as polyethylene oxide or polyvinylidene fluoride in addition to the solid electrolyte.

A thickness of the electrolyte layer 15 is, for example, equal to or greater than 5 μm and equal to or less than 150 μm.

The solid electrolyte may have a particle shape. The solid electrolyte may be a sintered body.

Next, the positive electrode terminal 16 and the negative electrode terminal 17 are described. These terminals 16 and 17 are, for example, low-resistance conductors. As the terminals 16 and 17, a cured electrically conductive resin containing electrically conductive metal particles such as Ag is used, for example. The terminals 16 and 17 may be an electrically conductive metal plate such as a SUS plate coated with an electrically conductive adhesive. Use of the electrically conductive adhesive makes it possible to hold a multilayer body of the plurality of cells 30 by two metal plates. The electrically conductive adhesive is not limited in particular as long as electric conductivity and adhesion can be maintained within a temperature range in which the laminated battery 100 is used and in a process for manufacturing the laminated battery 100. A configuration, a thickness, and a material of the electrically conductive adhesive are not limited in particular as long as when a current at a maximum rate requested under an environment in which the laminated battery 100 is used is passed through the electrically conductive adhesive, the electrically conductive adhesive does not affect a life property and a battery property of the laminated battery 100 and durability of the electrically conductive adhesive can be maintained. The terminals 16 and 17 may be plated, for example, with Ni—Sn.

The positive electrode current collector 11 and the negative electrode current collector 13 are not limited in particular as long as the positive electrode current collector 11 and the negative electrode current collector 13 are made of an electrically conductive material. Examples of the material of the current collectors 11 and 13 include stainless, nickel, aluminum, iron, titanium, copper, palladium, gold, and platinum. These materials of the current collectors 11 and 13 may be used alone or may be used as an alloy combining two or more kinds. The current collectors 11 and 13 may have a foil shape, a plate shape, a mesh shape, or the like. The material of the current collectors 11 and 13 are not limited in particular as long as the current collectors 11 and 13 do not melt and decompose due to a manufacturing process of the battery 100, a temperature at which the battery 100 is used, and a pressure in the battery 100 and can be selected as appropriate in consideration of an operating potential of the battery 100 applied to the current collectors 11 and 13 and electric conductivity of the current collectors 11 and 13. Furthermore, the material of the current collectors 11 and 13 can also be selected in accordance with tensile strength and heat resistance requested for the current collectors 11 and 13. Examples of the material of the current collectors 11 and 13 include copper, aluminum, and alloys containing copper and aluminum as main components. The current collectors 11 and 13 may be an electrolytic copper foil having a high strength or a clad material made up of different metal foils laminated on one another. A thickness of the current collectors 11 and 13 is, for example, equal to or greater than 10 μm and equal to or less than 100 μm.

The above configurations of the laminated battery 100 may be combined as appropriate.

The configuration of the battery 100 according to the present embodiment is different from the configuration of the battery described in Patent Literature 1 and the configuration of the battery described in Patent Literature 2 in the following points.

Patent Literature 1 discloses a thin-film solid-state secondary battery that has an electrode extraction part at an end of a body of a current collector. The battery described in Patent Literature 1 has an electrode extraction part that is a film formed so as to extend to an outer side of a negative electrode active material layer and be exposed to atmosphere.

Patent Literature 2 discloses an all-solid-state battery in which a current collector for a terminal is attached to an end surface of a multilayer body including parallel current collectors. However, in the all-solid-state battery of Patent Literature 2, there is no gap between the current collector for a terminal and the parallel current collectors.

The configuration of the battery described in Patent Literature 1 and the configuration of the battery described in Patent Literature 2 are different from the configuration of the battery 100 according to the present embodiment in position of an electrode for taking out a current from a current collector and configuration of the current collector and therefore may cause the following problems.

According to the configuration of the battery of Patent Literature 1, the electrode extraction part of a current collector layer is formed as a film so as to be exposed to the atmosphere. Accordingly, peeling is easy to occur on an interface between the exposed current collector layer and a solid electrolyte layer. In a case where shock is applied to the battery of Patent Literature 1, a problem may occur in mechanical connection strength of the battery. Furthermore, in a case where thermal shock occurs, stress is generated due to a difference in coefficient of thermal expansion between the current collector layer and the solid electrolyte layer. As a result, peeling is easy to occur on the interface between the current collector layer and the solid electrolyte layer. Furthermore, durability of the battery against a cooling/heating cycle tends to be insufficient. Furthermore, in Patent Literature 1, a foreign substance is sometimes attached to the exposed part of the current collector layer. This may cause short circuit.

Contrary to Patent Literature 1 and Patent Literature 2, the plurality of cells 30 are electrically connected in parallel and integrated in the battery 100 according to the present embodiment. In the battery 100, the positive electrode current collector 11 and the negative electrode terminal 17 are electrically separate from each other with a gap interposed therebetween, and the negative electrode current collector 13 and the positive electrode terminal 16 are electrically separate from each other with a gap interposed therebetween. Furthermore, in the battery 100 according to the present embodiment, for example, the negative electrode current collector 13 is embedded in the electrolyte layer 15, and the exposed portion 13a of the negative electrode current collector 13 is connected to the negative electrode terminal 17. Accordingly, the above problems are less likely to occur in the battery 100 according to the present embodiment. Patent Literatures 1 and 2 do not disclose the above configuration of the battery 100 according to the present embodiment.

### Method for Manufacturing Battery

Next, an example of a method for manufacturing the battery 100 according to the present embodiment is described. The battery 100 according to the present embodiment can be manufactured, for example, by a sheet producing method.

Hereinafter, a step of producing the cell 30 is sometimes referred to as a “sheet producing step”. In the sheet producing step, for example, a multilayer body in which precursors of the constituent elements of the cell 30 included in the battery 100 according to the present embodiment are laminated is produced. In the multilayer body, for example, a precursor of the positive electrode current collector 11, a sheet of the positive electrode layer 12, a sheet of the electrolyte layer 15, a sheet of the negative electrode layer 14, and a precursor of the negative electrode current collector 13 are laminated in this order. A predetermined number of multilayer bodies are produced corresponding to the number of cells 30 to be connected in parallel. An order in which the members included in the multilayer body are formed is not limited in particular.

First, a sheet producing step is described. The sheet producing step includes a step of producing sheets that are precursors of the elements of the cell 30 and laminating the sheets.

The sheet of the positive electrode layer 12 can be, for example, produced by the following method. First, slurry for producing the sheet of the positive electrode layer 12 is obtained by mixing a positive electrode active material, a solid electrolyte as a mixture, a conductive additive, a binder, and a solvent. Hereinafter, the slurry for producing the sheet of the positive electrode layer 12 is sometimes referred to as “positive electrode active material slurry”. Next, the positive electrode active material slurry is applied onto the precursor of the positive electrode current collector 11, for example, by a printing method. By drying a coating film thus obtained, the sheet of the positive electrode layer 12 is formed.

For example, a copper foil having a thickness of approximately 30 μm can be used as the precursor of the positive electrode current collector 11. As the positive electrode active material, for example, powder of an Li.Ni.Co.Al composite oxide (LiNi_{0.8}Co_{0.15}Al_{0.05}O₂) having an average particle diameter of approximately 5 μm and having a layered structure can be used. As the solid electrolyte as a mixture, for example, glass powder of Li₂S—P₂S₅ sulfide having an average particle diameter of approximately 10 μm and containing triclinic crystal as a main component can be used. The solid electrolyte has, for example, high ion conductivity of 2×10⁻³ S/cm or more and 3×10⁻³ S/cm or less.

The positive electrode active material slurry can be applied onto one surface of the copper foil that is the precursor of the positive electrode current collector 11, for example, by a screen printing method. An obtained coating film has, for example, a predetermined shape and a thickness of approximately 50 μm or more and 100 μm or less. Next, the sheet of the positive electrode layer 12 is obtained by drying the coating film. The coating film may be dried at a temperature of 80° C. or more and 130° C. or less. A thickness of the sheet of the positive electrode layer 12 is, for example, equal to or greater than 30 μm and equal to or less than 60 μm.

The sheet of the negative electrode layer 14 can be, for example, produced by the following method. First, slurry for producing the sheet of the negative electrode layer 14 is obtained by mixing a negative electrode active material, a solid electrolyte, a conductive additive, a binder, and a solvent. Hereinafter, the slurry for producing the sheet of the negative electrode layer 14 is sometimes referred to as “negative electrode active material slurry”. The negative electrode active material slurry is applied onto the precursor of the negative electrode current collector 13, for example, by a printing method. By drying an obtained coating film, the sheet of the negative electrode layer 14 is formed.

For example, a copper foil having a thickness of approximately 30 μm can be used as the precursor of the negative electrode current collector 13. As the negative electrode active material, for example, powder of natural graphite having an average particle diameter of approximately 10 μm can be used. As the solid electrolyte, one exemplified in the method for producing the sheet of the positive electrode layer 12 can be used, for example.

The negative electrode active material slurry can be applied onto one side of the copper foil that is the precursor of the negative electrode current collector 13, for example, by a screen printing method. The obtained coating film has, for example, a predetermined shape and a thickness of approximately 50 μm or more and approximately 100 μm or less. Next, by drying the coating film, the sheet of the negative electrode layer 14 is obtained. The coating film may be dried at a temperature of 80° C. or more and 130° C. or less. The thickness of the sheet of the negative electrode layer 14 is, for example, equal to or greater than 30 μm and equal to or less than 60 μm.

The sheet of the electrolyte layer 15 is disposed between the sheet of the positive electrode layer 12 and the sheet of the negative electrode layer 14. The sheet of the electrolyte layer 15 can be produced, for example, by the following method. First, slurry for producing the sheet of the electrolyte layer 15 is obtained by mixing a solid electrolyte, a conductive additive, a binder, and a solvent. Hereinafter, the slurry for producing the sheet of the electrolyte layer 15 is sometimes referred to as “solid electrolyte slurry”. The solid electrolyte slurry is applied onto the sheet of the positive electrode layer 12. Similarly, the solid electrolyte slurry is applied onto the sheet of the negative electrode layer 14. The solid electrolyte slurry is applied, for example, by a printing method using a metal mask. An obtained coating film has, for example, a thickness of approximately 100 μm. Next, the coating film is dried. The coating film may be dried at a temperature of 80° C. or more and 130° C. or less. As a result, the sheet of the electrolyte layer 15 is formed on the sheet of the positive electrode layer 12 and the sheet of the negative electrode layer 14.

The method for producing the sheet of the electrolyte layer 15 is not limited to the above method. The sheet of the electrolyte layer 15 may be produced by the following method. First, solid electrolyte slurry is applied onto a substrate, for example, by using a printing method. The substrate is not limited in particular as long as the sheet of the electrolyte layer 15 can be formed thereon, and contains Teflon® polyethylene terephthalate (PET), or the like. The substrate has, for example, a film shape or a foil shape. Next, the sheet of the electrolyte layer 15 can be obtained by drying a coating film formed on the substrate. To use the sheet of the electrolyte layer 15, the sheet of the electrolyte layer 15 is peeled off from the substrate.

The solvents used for the positive electrode active material slurry, the negative electrode active material slurry, and the solid electrolyte slurry are not limited in particular as long as the solvents dissolve a binder and do not affect a battery property. Examples of the solvents include alcohols such as ethanol, isopropanol, n-butanol, and benzyl alcohol, organic solvents such as toluene, ethyl acetate, butyl acetate, acetone, methyl ethyl ketone, methyl isobutyl ketone, ethylene glycol ethyl ether, isophorone, butyl lactate, dioctyl phthalate, dioctyl adipate, N,N-dimethylformamide (DMF), and N-methyl-2-pyrolidone (NMP), and water. These solvents may be used alone or may be used in combination of two or more kinds.

Although the screen printing method has been illustrated as a method for applying the positive electrode active material slurry, the negative electrode active material slurry, and the solid electrolyte slurry in the present embodiment, the applying method is not limited to this. As the applying method, a doctor blade method, calendering, spin coating, dip coating, an inkjet method, an offset method, a die coating, spraying, or the like can be used.

In the positive electrode active material slurry, the negative electrode active material slurry, and the solid electrolyte slurry, an auxiliary agent such as a plasticizer may be mixed as needed in addition to the positive electrode active material, the negative electrode active material, the solid electrolyte, the conductive additive, the binder, and the solvent. The method for mixing the slurry is not limited in particular. An additive such as a thickener, a plasticizer, a defoamer, a leveling agent, or an adhesion giving agent may be added to the slurry as needed.

Next, the sheet of the electrolyte layer 15 formed on the sheet of the positive electrode layer 12 and the sheet of the electrolyte layer 15 formed on the sheet of the negative electrode layer 14 are superimposed on each other. As a result, a multilayer body in which the precursor of the positive electrode current collector 11, the positive electrode layer 12, the electrolyte layer 15, the negative electrode layer 14, and the precursor of the negative electrode current collector 13 are laminated in this order is obtained.

Next, the precursor of the positive electrode current collector 11 is cut so that the positive electrode current collector 11 is obtained. Specifically, the precursor of the positive electrode current collector 11 is cut so that the positive electrode current collector 11 and the negative electrode terminal 17 are electrically separate from each other with a gap interposed therebetween when the negative electrode terminal 17 is disposed. A cut surface of the positive electrode current collector 11, for example, extends straight in the second direction y. The precursor of the positive electrode current collector 11 can be cut, for example, by laser. By cutting the precursor of the positive electrode current collector 11, the positive electrode current collector 11 can be formed. A shortest distance between the positive electrode current collector 11 and the negative electrode terminal 17 is, for example, 10 μm. The positive electrode current collector 11 and the negative electrode terminal 17 are electrically separate from each other due to the gap between the positive electrode current collector 11 and the negative electrode terminal 17. That is, the gap between the positive electrode current collector 11 and the negative electrode terminal 17 is electrically insulating.

Next, the precursor of the negative electrode current collector 13 is cut so that the negative electrode current collector 13 can be obtained. Specifically, the precursor of the negative electrode current collector 13 is cut so that the negative electrode current collector 13 and the positive electrode terminal 16 are electrically separate from each other with a gap interposed therebetween when the positive electrode terminal 16 is disposed. A cutting surface of the negative electrode current collector 13, for example, extends straight in the second direction y. The precursor of the negative electrode current collector 13 can be cut, for example, by laser. By cutting the precursor of the negative electrode current collector 13, the negative electrode current collector 13 can be formed. A shortest distance between the negative electrode current collector 13 and the positive electrode terminal 16 is, for example, 10 μm. The negative electrode current collector 13 and the positive electrode terminal 16 are electrically separate from each other due to the gap between the negative electrode current collector 13 and the positive electrode terminal 16. That is, the gap between the negative electrode current collector 13 and the positive electrode terminal 16 is electrically insulating.

An order of cutting of the precursor of the positive electrode current collector 11 and cutting of the precursor of the negative electrode current collector 13 is not limited in particular. The precursor of the negative electrode current collector 13 may be cut after the precursor of the positive electrode current collector 11 is cut or the precursor of the positive electrode current collector 11 may be cut after the precursor of the negative electrode current collector 13 is cut. The precursor of the positive electrode current collector 11 and the precursor of the negative electrode current collector 13 may be cut before the sheet of the electrolyte layer 15 formed on the sheet of the positive electrode layer 12 and the sheet of the electrolyte layer 15 formed on the sheet of the negative electrode layer 14 are superimposed on each other. The precursor of the positive electrode current collector 11 and the precursor of the negative electrode current collector 13 may be cut by using means such as dicing. An insulating part may be provided by cutting the precursor of the positive electrode current collector 11 and removing a part of the precursor.

As described above, the cell 30 is obtained by cutting the precursor of the positive electrode current collector 11 and then cutting the precursor of the negative electrode current collector 13.

Next, a predetermined number of cells 30 are prepared. For example, an electrically conductive adhesive is applied onto a main surface of the positive electrode current collector 11 exposed to an outside of the cell 30 and a main surface of the negative electrode current collector 13 exposed to an outside of the cell 30. The electrically conductive adhesive is applied, for example, by a screen printing method. Hereinafter, the main surface of the positive electrode current collector 11 and the main surface of the negative electrode current collector 13 onto which the adhesive material has been applied are sometimes referred to as “adhesive surfaces”. Next, the adhesive surface of the positive electrode current collector 11 of the cell 30 is bonded to the adhesive surface of the positive electrode current collector 11 of another cell 30 or the adhesive surface of the negative electrode current collector 13 of the cell 30 is bonded to the adhesive surface of the negative electrode current collector 13 of another cell 30. In this way, the plurality of cells 30 can be laminated. The adhesive surfaces can be bonded to each other, for example, by pressure bonding. A temperature at which the adhesive surfaces are bonded to each other is, for example, equal to or higher than 50° C. and equal to or lower than 100° C. A pressure applied to the cells 30 when the adhesive surfaces are bonded to each other is, for example, equal to or higher than 300 MPa and equal to or less than 400 MPa. A period for which the pressure is applied to the cells 30 is, for example, equal to or longer than 90 seconds and equal to or shorter than 120 seconds. A low-resistance electrically conductive tape may be used instead of the electrically conductive adhesive. Silver powder paste or copper powder paste may be used instead of the electrically conductive adhesive. Current collectors can be mechanically joined to each other with metal particles interposed therebetween by an anchor effect by pressure-bonding the adhesive surface of the cell 30 to which the silver powder paste or copper powder paste has been applied to the adhesive surface of another cell 30. A method for laminating the plurality of cells 30 is not limited in particular as long as adhesiveness and electric conductivity can be obtained.

Next, each of the plurality of cells 30 is electrically connected to the positive electrode terminal 16 and the negative electrode terminal 17. Each of the plurality of cells 30 and the terminals 16 and 17 can be electrically connected, for example, by the following method. First, electrically conductive resin paste is applied onto surfaces of the multilayer body of the plurality of cells 30 on which the terminals 16 and 17 are to be disposed. The terminals 16 and 17 are formed by curing the electrically conductive resin paste. As a result, the battery 100 according to the present embodiment is obtained. A temperature at which the electrically conductive resin paste is cured is, for example, equal to or higher than approximately 100° C. and equal to or less than approximately 300° C. A period for which the electrically conductive resin paste is cured is, for example, 60 minutes.

The electrically conductive resin paste can be, for example, thermosetting electrically conductive paste containing highly electrically conductive metal particles having a high melting point containing Ag, Cu, Ni, Zn, Al, Pd, Au, Pt, or an alloy thereof, low-melting-point metal particles, and a resin. The melting point of the highly electrically conductive metal particles is, for example, equal to or higher than 400° C. The melting point of the low-melting-point metal particles may be equal to or lower than a curing temperature of the electrically conductive resin paste or may be equal to or lower than 300° C. Examples of a material of the low-melting-point metal particles include Sn, SnZn, SnAg, SnCu, SnAl, SnPb, In, InAg, InZn, InSn, Bi, BiAg, BiNi, BiSn, BiZn, and BiPb. By using such electrically conductive paste containing low-melting-point metal powder, solid phase and liquid phase reaction proceed in a portion where the electrically conductive paste and a current collector are in contact at a thermosetting temperature lower than the melting point of the low-melting-point metal particles. This, for example, forms an alloy of a metal contained in the electrically conductive paste and a metal contained in the current collector. A diffusion layer containing the alloy is formed close to a portion where the current collector and the terminal is connected. In a case where Ag or an Ag alloy is used as the electrically conductive particles and Cu is used for the current collector, a highly electrically conductive alloy containing AgCu is formed. Furthermore, AgNi, AgPd, or the like can also be formed depending on a combination of a material of the electrically conductive particles and a material of the current collector. In this way, the terminal and the current collector are integrally joined by the diffusion layer containing the alloy. According to such a configuration, the terminal and the current collector are connected more firmly than the anchor effect. Accordingly, a problem that the members of the battery 100 are disengaged from each other due to a difference in thermal expansion among the members caused by a thermal cycle or due to a shock is less likely to occur.

A shape of the highly electrically conductive metal particles and the low-melting-point metal particles is not limited in particular and may be a spherical shape, a scale shape, or a needle shape. Alloying reaction and diffusion of the alloy proceed at a lower temperature as the particle size of these metal particles becomes smaller. Accordingly, the particle size and the shape of these metal particles can be adjusted as appropriate in consideration of influence of a heat history on process design and battery property.

The resin used for the thermosetting electrically conductive paste is not limited in particular as long as the resin functions as a binder, and an appropriate one can be selected depending on a production process to be employed such as adequacy to a printing method and an application property. Examples of the resin used for the thermosetting electrically conductive paste include a thermosetting resin. Examples of the thermosetting resin include amino resins such as a urea-formaldehyde resin, a melamine resin, and a guanamine resin, epoxy resins such as a bisphenol A type, a bisphenol F type, a phenol novolac type, and an alicyclic type, phenolic resins such as an oxetane resin, a resol type, and a novolac type, and silicone modified organic resins such as silicone epoxy and silicone polyester. These resins may be used alone or may be used in combination of two or more kinds.

In the present embodiment, the battery 100 may further include a joining layer in order to improve a joining strength between a current collector and the electrolyte layer 15. The joining layer is located on an interface between the positive electrode current collector 11 and the electrolyte layer 15. Furthermore, the joining layer is located on an interface between a contact portion of a side surface of the negative electrode current collector 13 and the electrolyte layer 15. A material of the joining layer is, for example, a component that constitutes the current collector. Examples of the component that constitutes the current collector include copper, aluminum, and an alloy containing copper and aluminum as main components. The joining layer may further contain an oxide, a sulfide, or a halide. The joining layer may further contain a component that constitutes the current collector and/or a component that constitutes the electrolyte layer 15. With the configuration, the current collector is firmly joined to the electrolyte layer 15 in the laminated battery 100. According to such a configuration, the laminated battery 100 integrated with a higher joining strength can be provided since a joining strength can be improved by chemical joining on the interface between the current collector and the electrolyte layer 15.

The joining layer can be produced by laminating and pressure-bonding the plurality of cells 30 as described above. For example, when the adhesive surfaces of the plurality of cells 30 are pressure-bonded, copper contained in the current collector and sulfide contained in the electrolyte layer 15 diffuse on the interface between the current collector and the electrolyte layer 15, and a copper sulfide layer is formed. This forms the joining layer. The joining layer may contain a substance other than copper sulfide. A temperature at which the joining layer is formed is, for example, 100° C. A period for formation of the joining layer is, for example, 5 minutes. A thickness of the joining layer thus formed is approximately 1 μm. However, the thickness of the joining layer is not limited in particular and may be, for example, equal to or greater than 0.1 μm and equal to or less than 10 μm.

Existence of the joining layer thus produced can be confirmed by observation of a cross section of the battery 100 by a normal light microscope, a laser microscope, or a scanning electron microscope (SEM). A composition of the joining layer can be evaluated, for example, by composition analysis using a joining layer electron probe micro analyzer (EPMA).

An example in which the battery 100 is manufactured by a powder compacting process has been illustrated in the manufacturing method according to the present embodiment. However, a multilayer body of sintered bodies may be used by using a heat-treating process, and the terminals 16 and 17 may be produced by applying electrically conductive resin paste onto the multilayer body and performing heat-treating.

The battery 100 is configured such that the plurality of cells 30 are connected in parallel while sharing the negative electrode current collector 13. The positive electrode current collector 11 is located on an upper surface and a lower surface of the cells. However, the battery may be configured such that the plurality of cells 30 are connected in parallel while sharing the positive electrode current collector 11. In this case, the negative electrode current collector 13 is located on an upper surface and a lower surface of the cells. Furthermore, a large portion of the positive electrode current collector 11 may be embedded in the electrolyte layer 15, and the positive electrode current collector 11 may have an exposed portion for contact with the positive electrode terminal 16.

### Second Embodiment

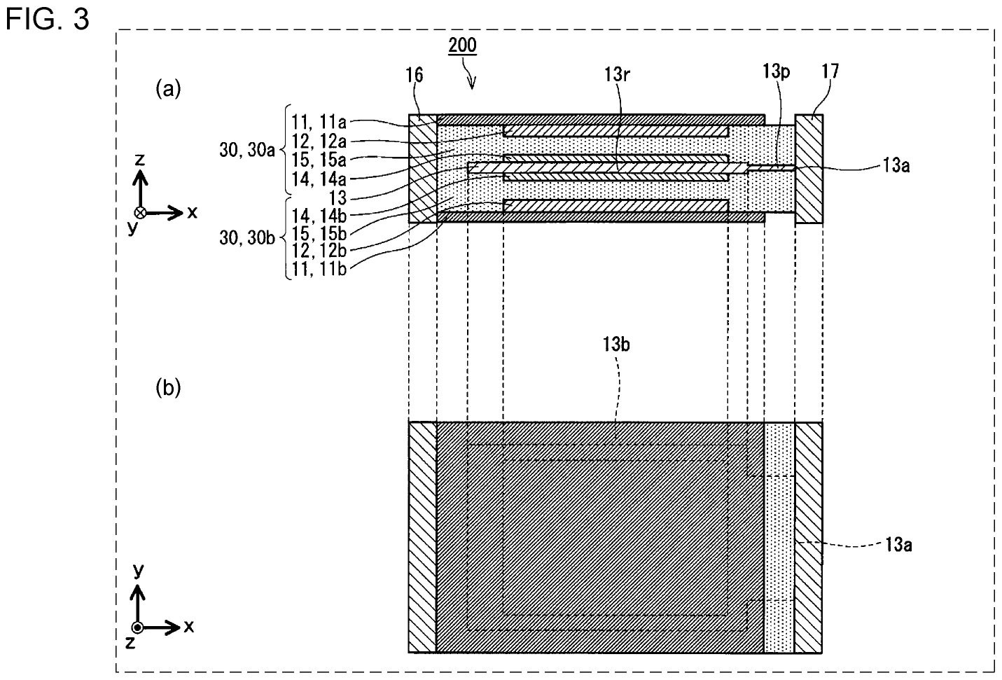

FIG. 3 is a schematic view for explaining a configuration of a battery 200 according to the second embodiment. FIG. 3(a) is a cross-sectional view of the battery 200 according to the present embodiment. FIG. 3(b) is a top view of the battery 200. Elements common to the battery 100 according to the first embodiment and the battery 200 according to the present embodiment are given identical reference signs, and description thereof is sometimes omitted. That is, the descriptions concerning the embodiments can be applied to each other unless technical inconsistency occurs. Furthermore, the embodiments may be combined with each other unless technical inconsistency occurs.

As illustrated in FIG. 3, in a negative electrode current collector 13, a thickness of a protruding portion 13p is smaller than a thickness of a remaining portion 13r. This can further reduce an area of an exposed portion 13a. It is therefore possible to reduce an interface between the exposed portion 13a and an electrolyte layer 15 without affecting electric properties of the battery 200. As a result, a portion where peeling is easy to occur between a negative electrode current collector 13 and the electrolyte layer 15 can be reduced, and therefore the battery 200 having high reliability can be provided.

Since the thickness of the protruding portion 13p is smaller than the thickness of the remaining portion 13r, variations in pressure during pressure bonding are reduced. Furthermore, since an area of the exposed portion 13a that is in contact with a negative electrode terminal 17 is small, the negative electrode current collector 13 is hard to be affected even in a case where stress caused by tension is generated in the negative electrode terminal 17. This can further improve a joining strength between the negative electrode current collector 13 and the electrolyte layer 15. Furthermore, since the plurality of cells 30 that are connected in parallel can be firmly integrated in a small size, the battery 200 having a large capacity, a high energy density, and high reliability can be provided.

A ratio (D2/D1) of the thickness D2 of the protruding portion 13p to the thickness D1 of the remaining portion 13r is decided appropriately according to a size, a material, and the like of the battery 200 and is not limited in particular. The ratio (D2/D1) is, for example, in a range of 3 or more and 10 or less.

The thickness of the protruding portion 13p and the thickness of the remaining portion 13r can be specified as averages of values measured at any plural points (e.g., five points). For example, a micrometer is used for the measurement. In the present embodiment, a thickness is a dimension in a direction parallel with the third direction z.

### Third Embodiment

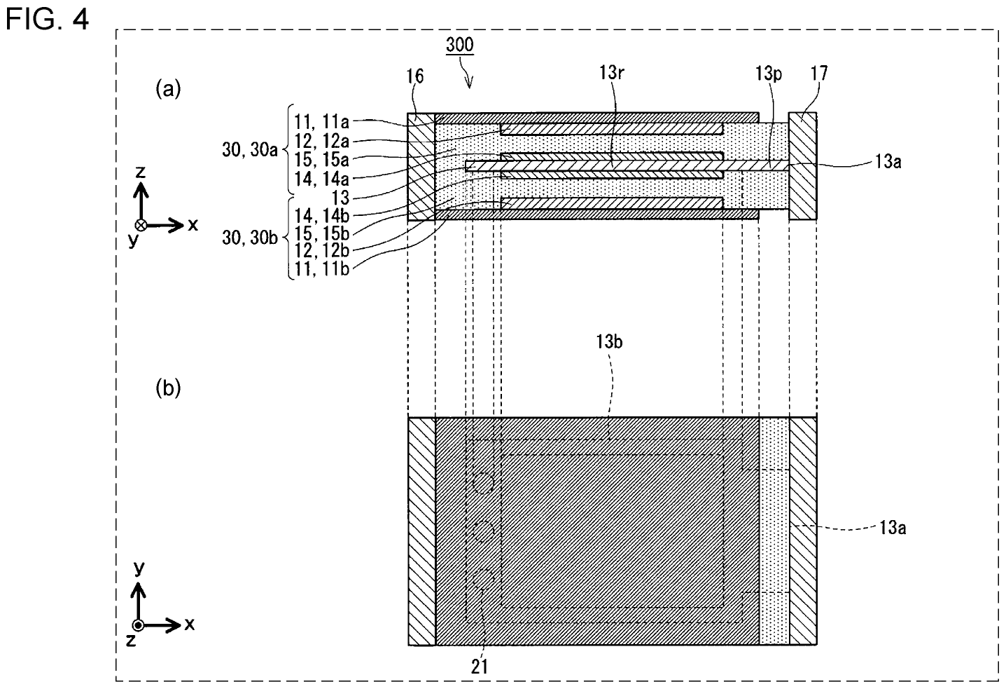

FIG. 4 is a schematic view for explaining a configuration of a battery 300 according to the third embodiment. FIG. 4(a) is a cross-sectional view of the battery 300 according to the present embodiment. FIG. 4(b) is a top view of the battery 300. As illustrated in FIG. 4, in the laminated battery 300, a negative electrode current collector 13 further has a lock hole 21. Hereinafter, the lock hole 21 is sometimes referred to as a “through hole”. Except for this, the structure of the battery 300 is identical to the structure of the battery 100 according to the first embodiment.

The lock hole 21 is, for example, a through hole that passes through the negative electrode current collector 13 in a direction in which the plurality of cells 30 are laminated. The lock hole 21 is provided in a portion where the negative electrode current collector 13 and an electrolyte layer 15 are in contact. The lock hole 21 is not provided in a portion where the negative electrode current collector 13 and a negative electrode layer 14 are in contact. The lock hole 21 may be provided in a remaining portion 13r of the negative electrode current collector 13 or may be provided in a protruding portion 13p of the negative electrode current collector 13. The electrolyte layer 15 is present in the lock hole 21. That is, the lock hole 21 is filled with an electrolyte of which the electrolyte layer 15 is made. According to such a configuration, a joining strength between the negative electrode current collector 13 and the electrolyte layer 15 can be improved by an anchor effect. Furthermore, since the plurality of cells 30 that are connected in parallel can be firmly integrated in a small size, the battery 300 having a large capacity, a high energy density, and high reliability can be provided.

A shape, a size, and the number of lock holes 21 are not limited in particular as long as a joining strength between the negative electrode current collector 13 and the electrolyte layer 15 can be improved. The lock hole 21 has, for example, a columnar shape. The size of the lock hole 21 is not limited in particular and may be equal to or greater than 200 μm and equal to or less than 500 μm in diameter, may be equal to or greater than 30 μm and equal to or less than 500 μm in diameter, or may be equal to or greater than 30 μm and equal to or less than 100 μm in diameter. The number of lock holes 21 provided in the negative electrode current collector 13 is not limited in particular.

A method for forming the lock hole 21 in the negative electrode current collector 13 is not limited in particular. For example, the lock hole 21 can be formed by cutting a precursor of the negative electrode current collector 13 after producing the precursor of the negative electrode current collector 13 as described above. Specifically, the lock hole 21 can be formed in the precursor of the negative electrode current collector 13 by cutting a portion of the negative electrode current collector 13 so that the cut portion passes through the negative electrode current collector 13 in the laminating direction. The lock hole 21, for example, extends straight in the direction in which the plurality of cells 30 are laminated. The precursor of the negative electrode current collector 13 can be cut, for example, by laser. The lock hole 21 can be formed in the negative electrode current collector 13 by cutting the precursor of the negative electrode current collector 13. Another example of formation of the lock hole 21 in the negative electrode current collector 13 is punching. In this case, the lock holes 21 can be formed by creating a large number of small holes in a metal sheet by punching of the negative electrode current collector 13. The plurality of lock holes 21 are provided, for example, at intervals of 50 μm. According to such a configuration, a joining strength between the negative electrode current collector 13 and the electrolyte layer 15 can be improved.

### Fourth Embodiment

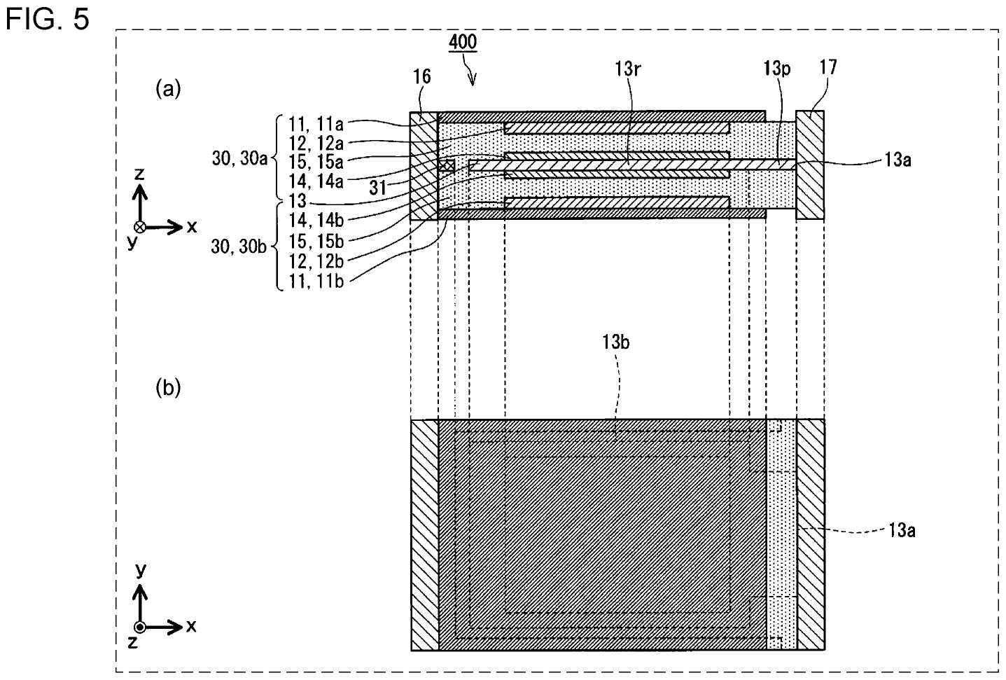

FIG. 5 is a schematic view for explaining a configuration of a battery 400 according to a fourth embodiment. FIG. 5(a) is a cross-sectional view of the battery 400 according to the present embodiment. FIG. 5(b) is a top view of the battery 400. As illustrated in FIG. 5, in the battery 400, each of a plurality of cells further includes a dummy current collector 31. Except for this, the structure of the battery 400 is identical to the structure of the battery 100 according to the first embodiment.

In the present embodiment, the dummy current collector 31 is located on a periphery of the battery 400. Furthermore, the dummy current collector 31 is located around a shielded portion 13b of a negative electrode current collector 13. According to such a configuration, variations in pressure are reduced during pressure bonding. Therefore, the battery 400 having high reliability can be provided. With this configuration, a density in a multilayer body tends to be uniform.

The dummy current collector 31 is electrically separate from the negative electrode current collector 13. That is, the negative electrode current collector 13 is electrically insulated from the dummy current collector 31. The dummy current collector 31 is separate from the negative electrode current collector 13 with a gap interposed therebetween. According to such a configuration, the dummy current collector 31 can function as a reinforcing member. Therefore, the battery 400 having high reliability can be provided.

A part of the dummy current collector 31 may be embedded in an electrolyte layer 15. The dummy current collector 31 may be exposed from the electrolyte layer 15. In other words, the dummy current collector 31 may have a part that is exposed from the electrolyte layer 15. The dummy current collector 31 may be in contact with the positive electrode terminal 16 in the exposed part. The dummy current collector 31 is, for example, not in contact with the negative electrode terminal 17. The dummy current collector 31 has, for example, a U-shape in plan view.

The dummy current collector 31 is located at the same height as the negative electrode current collector 13 in a direction in which the plurality of cells 30 are laminated. It is therefore possible to reduce stress generated concentratedly around the negative electrode current collector 13 due to bending of the current collector during pressure bonding. With this configuration, a density in a multilayer body tends to be uniform. As a result, a structural defect in the battery 400 is reduced. Furthermore, a portion where peeling is easy to occur between the negative electrode current collector 13 and the electrolyte layer 15 can be reduced, and therefore the battery 400 having high reliability can be provided. Furthermore, the battery 400 that can reduce stress caused by bending of a current collector can be easily manufactured by forming the dummy current collector 31.

The dummy current collector 31 can be produced, for example, by the following method. First, a precursor of the negative electrode current collector 13 is produced as described above. Next, the precursor of the negative electrode current collector 13 is cut so that the dummy current collector 31 is obtained. Specifically, the precursor of the negative electrode current collector 13 is cut so that the negative electrode current collector 13 and the dummy current collector 31 are electrically separate from each other with a gap interposed therebetween. A cutting surface of the negative electrode current collector 13, for example, extends straight in the first direction x and the second direction y. The precursor of the negative electrode current collector 13 can be cut, for example, by laser. The negative electrode current collector 13 and the dummy current collector 31 can be formed by cutting the precursor of the negative electrode current collector 13. The gap between the negative electrode current collector 13 and the dummy current collector 31 is, for example, 30 μm. The precursor of the negative electrode current collector 13 may be cut by means such as dicing. The dummy current collector 31 may be formed by cutting the precursor of the negative electrode current collector 13 and removing a part of the precursor.

To be exact, the dummy current collector 31 does not function as a current collector. Accordingly, a material used for the dummy current collector 31 is not limited in particular. For example, the dummy current collector 31 may contain the same material as the positive electrode current collector 11 or the negative electrode current collector 13 or may contain an insulating material. The dummy current collector 31 may be produced from the same material as the positive electrode current collector 11 or the negative electrode current collector 13 or may be produced from an insulating material. In a case where the dummy current collector 31 has the same degree of hardness as the positive electrode current collector 11 or the negative electrode current collector 13, variations in pressure can be further reduced during pressure bonding. Therefore, the battery 400 having high reliability can be provided. From this perspective, the dummy current collector 31 can be made of the same material as the current collector 11 and/or the current collector 13.

The dummy current collector 31 may further have a lock hole. The lock hole is, for example, a through hole that passes through the dummy current collector 31 in a direction in which the plurality of cells 30 are laminated. The electrolyte layer 15 is present in the lock hole. That is, the lock hole is filled with an electrolyte of which the electrolyte layer 15 is made. According to such a configuration, a joining strength between the dummy current collector 31 and the electrolyte layer 15 can be improved by an anchor effect. Since the plurality of cells 30 that are connected in parallel can be firmly integrated in a small size, the battery 400 having a large capacity, a high energy density, and high reliability can be provided.

A shape, a size, and the number of lock holes are not limited in particular as long the joining strength between the dummy current collector 31 and the electrolyte layer 15 can be improved. The lock hole has, for example, a columnar shape. The size of the lock hole is not limited in particular and may be equal to or greater than 200 μm and equal to or less than 500 μm in diameter, may be equal to or greater than 30 μm and equal to or less than 500 μm in diameter, or may be equal to or greater than 30 μm and equal to or less than 100 μm in diameter. The number of lock holes provided in the dummy current collector 31 is not limited in particular.

A method for forming the lock hole in the dummy current collector 31 is not limited in particular. The lock hole can be formed by a method similar to the method for forming the lock hole 21. A plurality of lock holes are provided, for example, at intervals of 50 μm. According to such a configuration, the joining strength between the dummy current collector 31 and the electrolyte layer 15 can be improved.

In the present embodiment, a joining layer may be further provided so as to improve the joining strength between the dummy current collector 31 and the electrolyte layer 15. The joining layer is located on an interface between the dummy current collector 31 and the electrolyte layer 15. A material of the joining layer may contain a component that constitutes the dummy current collector 31 and/or a component that constitutes the electrolyte layer 15. According to such a configuration, the joining strength can be improved by chemical joining on the interface between the dummy current collector 31 and the electrolyte layer 15. Therefore, the laminated battery 400 that is integrated with high joining strength can be provided.

### Fifth Embodiment

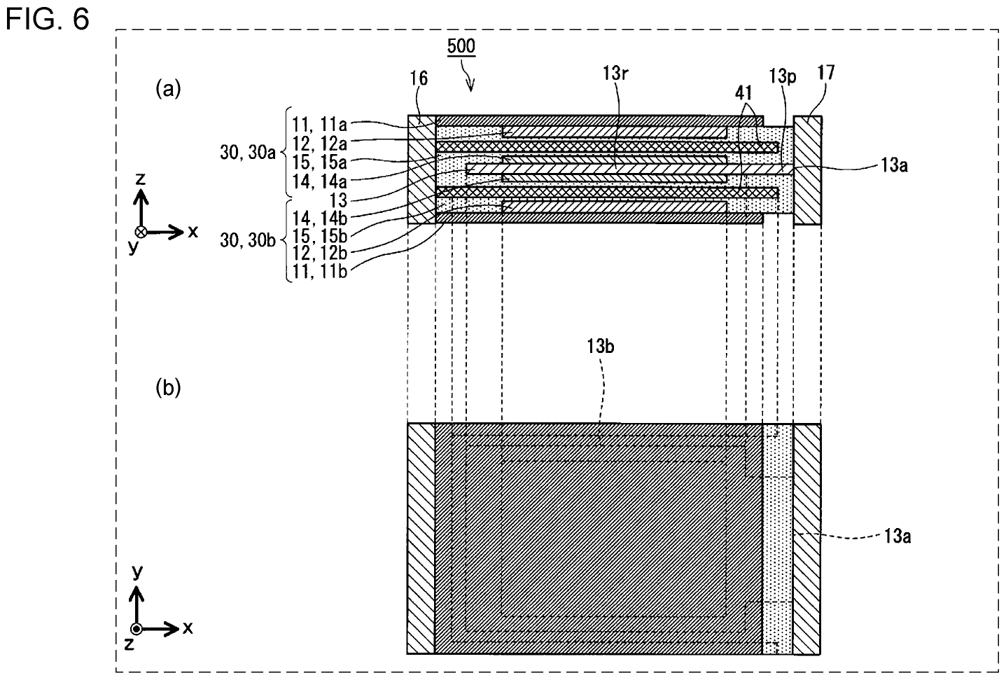

FIG. 6 is a schematic view for explaining a configuration of a battery 500 according to the fifth embodiment. FIG. 6(a) is a cross-sectional view of the battery 500 according to the present embodiment. FIG. 6(b) is a top view of the battery 500. As illustrated in FIG. 6, in the battery 500, each of a plurality of cells further includes a dummy current collector 41. Except for this, a structure of the battery 500 is identical to the structure of the battery 100 according to the first embodiment.

In the present embodiment, the dummy current collector 41 is located on a periphery of the battery 500. However, the battery 500 is different from the battery 400 in that the dummy current collector 41 is disposed on a plane different from a negative electrode current collector 13. That is, the dummy current collector 41 is located at a height different from the negative electrode current collector 13 in a direction in which the plurality of cells 30 are laminated. The dummy current collector 41 is electrically separate from a positive electrode current collector 11, a positive electrode layer 12, and a negative electrode layer 14. A part of the dummy current collector 41 may be embedded in the electrolyte layer 15. The dummy current collector 41 may be exposed from the electrolyte layer 15. In other words, the dummy current collector 41 may have a part exposed from the electrolyte layer 15. The dummy current collector 41 may be in contact with the positive electrode terminal 16 in the exposed part. The dummy current collector 41 is, for example, not in contact with the negative electrode terminal 17. The dummy current collector 41 has, for example, a U-shape in plan view. According to such a configuration, stress caused by a difference in coefficient of thermal expansion between a current collector and the electrolyte layer 15 can be reduced even in a case where thermal shock occurs. Accordingly, peeling is hard to occur between the negative electrode current collector 13 and the electrolyte layer 15. As a result, the battery 500 having high reliability against a heat cycle can be provided.

The dummy current collector 41 can be produced, for example, by the following method. First, a precursor of the dummy current collector 41 is formed on a sheet of the electrolyte layer 15. Next, the precursor of the dummy current collector 41 is cut so that the dummy current collector 41 is obtained. Specifically, the precursor of the dummy current collector 41 is cut so that the dummy current collector 41 is located on a periphery of a cell. A cutting surface of the precursor of the dummy current collector 41, for example, extends straight in the first direction x and the second direction y. The precursor of the dummy current collector 41 can be cut, for example, by laser. The dummy current collector 41 can be formed by cutting the precursor of the dummy current collector 41. The precursor of the dummy current collector 41 may be cut by means such as dicing.

To be exact, the dummy current collector 41 does not function as a current collector. Accordingly, a material used for the dummy current collector 41 is not limited in particular. For example, the dummy current collector 41 may be made of the same material as the dummy current collector 31. In a case where the dummy current collector 41 has the same degree of hardness as the positive electrode current collector 11 or the negative electrode current collector 13, stress caused by a difference in coefficient of thermal expansion between a current collector and the electrolyte layer 15 can be reduced even in a case where thermal shock occurs. Accordingly, peeling is hard to occur between the negative electrode current collector 13 and the electrolyte layer 15. As a result, the battery 500 having high reliability against a heat cycle can be provided.

The dummy current collector 41 may further have a lock hole, as in the case of the dummy current collector 31. The lock hole is, for example, a through hole that passes through the dummy current collector 41 in the direction in which the plurality of cells 30 are laminated. The electrolyte layer 15 is present in the lock hole. That is, the lock hole is filled with an electrolyte of which the electrolyte layer 15 is made. According to such a configuration, the joining strength between the dummy current collector 41 and the electrolyte layer 15 can be improved by an anchor effect. Since the plurality of cells 30 that are connected in parallel can be firmly integrated in a small size, the battery 500 having a large capacity, a high energy density, and high reliability can be provided.

Although batteries and laminated batteries according to the present disclosure have been described based on the embodiments, the present disclosure is not limited to these embodiments. Various modifications of the embodiments which a person skilled in the art can think of and other forms constructed by combining constituent elements in the embodiments are also encompassed within the scope of the present disclosure without departing from the spirit of the present disclosure.

A battery according to the present disclosure can be used as a secondary battery such as an all-solid-state battery used in various electronic appliances, automobiles, and the like.

What is claimed is:

1. A battery comprising:
a plurality of cells that are electrically connected in parallel, each of the plurality of cells including a positive electrode layer, a negative electrode layer, a current collector that is in contact with the positive electrode layer or the negative electrode layer, and an electrolyte layer disposed between the positive electrode layer and the negative electrode layer,
wherein a side surface of the current collector includes an exposed portion exposed from the electrolyte layer and a shielded portion shielded by the electrolyte layer, and
an area of the shielded portion is larger than an area of the exposed portion.

2. The battery according to claim 1, further comprising a terminal electrically connected to the current collector,
wherein the exposed portion is in contact with the terminal.

3. The battery according to claim 1, wherein
the electrolyte layer is a solid electrolyte layer containing a solid electrolyte.

4. The battery according to claim 1, wherein
the electrolyte layers of adjacent ones of the plurality of cells are joined to each other around the shielded portion.

5. The battery according to claim 1, wherein
the current collector has a protruding portion; and
the exposed portion is included in the protruding portion.

6. The battery according to claim 5, wherein
the current collector has a remaining portion other than the protruding portion; and
a width of the protruding portion is smaller than a width of the remaining portion.

7. The battery according to claim 5, wherein
the current collector has a remaining portion other than the protruding portion; and
a thickness of the protruding portion is smaller than a thickness of the remaining portion.

8. The battery according to claim 1, wherein
the current collector has a through hole.

9. The battery according to claim 8, wherein
the electrolyte layer is present in the through hole.

10. The battery according to claim 1, further comprising a joining layer,
wherein the joining layer is located on an interface between the current collector and the electrolyte layer and contains at least one kind of element among elements contained in the current collector and at least one kind of element among elements contained in the electrolyte layer.

11. The battery according to claim 10, wherein
the joining layer is present on an interface between the shielded portion and the electrolyte layer.

12. The battery according to claim 1, further comprising a dummy current collector around the shielded portion of the current collector.

13. The battery according to claim 12, wherein
the dummy current collector contains the same material as the current collector.

14. The battery according to claim 12, wherein
the dummy current collector contains an insulating material.

15. The battery according to claim 12, wherein
the dummy current collector is electrically separate from the current collector.

16. The battery according to claim 15, wherein
the dummy current collector is separate from the current collector.

17. The battery according to claim 12, wherein
the dummy current collector is exposed from the electrolyte layer.

18. The battery according to claim 12, wherein
each of the plurality of cells has a flat plate shape;
the plurality of cells are laminated on one another to constitute the battery; and
the dummy current collector is located at the same height as the current collector in a direction in which the plurality of cells are laminated.

19. The battery according to claim 12, wherein
each of the plurality of cells has a flat plate shape;
the plurality of cells are laminated on one another to constitute the battery; and
the dummy current collector is located at a height different from the current collector in a direction in which the plurality of cells are laminated.
